(19) United States
(12) Patent Application Publication
(10) Pub. No.: US 2012/0240966 A1
(43) Pub. Date: Sep. 27, 2012

(54) OUTER WALL CLEANER

(76) Inventor: Shun-Yuan CHEN, New Taipei City (TW)

(21) Appl. No.: 13/069,981

(22) Filed: Mar. 23, 2011

(51) Int. Cl. B08B 3/00

(52) U.S. Cl. 134/115 R

(57) ABSTRACT

An outer wall cleaner for washing an outer wall of a building includes a frame; an upper water inlet and a lower water inlet which are disposed on a front side of the frame and adapted to face the outer wall of the building; a water-driving member disposed within the frame and adapted to communicate with the upper and lower water inlets; a scrubbing member disposed on the front side of the frame and positioned between the upper and lower water inlets; a water-spraying member disposed on the front side of the frame and positioned between the upper and lower water inlets; and a water-taking member disposed on the front side of the frame, adapted to come into contact with the outer wall of the building and take water, and positioned above the upper water inlet, wherein an opening is disposed on a water-taking-member-facing side of the upper water inlet.

### FIELD OF THE INVENTION

The present invention relates to outer wall cleaners, and more particularly, to an outer wall cleaner for cleaning an outer wall of a building safely without contaminating an area below the outer wall.

### BACKGROUND OF THE INVENTION

High-rise buildings abound in every modern city. The surfaces of high-rise buildings become dirty as a result of sunshine and wind. To maintain the tidiness and cleanness of the high-rise buildings, the owners of the high-rise buildings hire building cleaning workers to wash the surfaces of the high-rise buildings on a scheduled basis. A typical way of cleaning the surfaces of the high-rise buildings involves: moving a building cleaning worker-riding platform across an outer wall of a building; spraying cleansing water to the outer wall of the building in a top-to-bottom manner; and scrubbing, by the building cleaning worker, the outer wall of the building with a tool to clean the outer wall of the building. However, the aforesaid way of cleaning the surfaces of the high-rise buildings has its drawbacks. First, it is not uncommon for a building cleaning worker or a building cleaning worker-riding platform to fall and result in casualties. Second, with a building cleaning worker spraying cleansing water to an outer wall of a building, the cleansing water falls under gravity inevitably or splashes, thereby bringing contamination to a sidewalk below and inconvenience to pedestrians.

Accordingly, it is imperative to devise an outer wall cleaner for cleaning an outer wall of a building safely without contaminating an area below the outer wall.

### SUMMARY OF THE INVENTION

In view of the above drawbacks of the prior art, the inventor of the present invention conducted extensive researches and experiments according to the inventor's years of experience in the related industry, and finally developed an outer wall cleaner for cleaning an outer wall of a building safely without contaminating an area below the outer wall.

In order to achieve the above and other objectives, the present invention provides an outer wall cleaner comprising: a frame; an upper water inlet disposed on a front side of the frame and adapted to face an outer wall of a building so as to take water; a lower water inlet disposed on the front side of the frame and adapted to face the outer wall of the building so as to take water; at least a water-driving member disposed within the frame and adapted to communicate with the upper water inlet and the lower water inlet so as to discharge water from another side of the frame; at least a scrubbing member disposed on the front side of the frame, positioned between the upper water inlet and the lower water inlet, and adapted to scrub the outer wall of the building; at least a water-spraying member disposed on the front side of the frame, positioned between the upper water inlet and the lower water inlet, and adapted to spray water onto the outer wall of the building; and a water-taking member disposed on the front side of the frame, adapted to come into contact with the outer wall of the building and take water, and positioned above the upper water inlet, wherein an opening is disposed on a water-taking-member-facing side of the upper water inlet.

Accordingly, an outer wall cleaner of the present invention is effective in cleaning an outer wall of a building safely without contaminating an area below the outer wall.

### BRIEF DESCRIPTION OF THE DRAWINGS

To enable persons skilled in the art to fully understand the objectives, features, and advantages of the present invention, the present invention is hereunder illustrated with specific embodiments in conjunction with the accompanying drawings, in which:

FIG. 1 is a schematic front view according to a specific embodiment of the present invention;

FIG. 2 is a schematic rear view according to a specific embodiment of the present invention;

FIG. 3 is a cross-sectional view according to a specific embodiment of the present invention;

FIG. 4 is a cross-sectional view of application according to a specific embodiment of the present invention;

FIG. 5 is a schematic top view of application according to a specific embodiment of the present invention; and

FIG. 6 is another schematic top view of application according to a specific embodiment of the present invention.

### DETAILED DESCRIPTION OF THE PREFERRED EMBODIMENTS

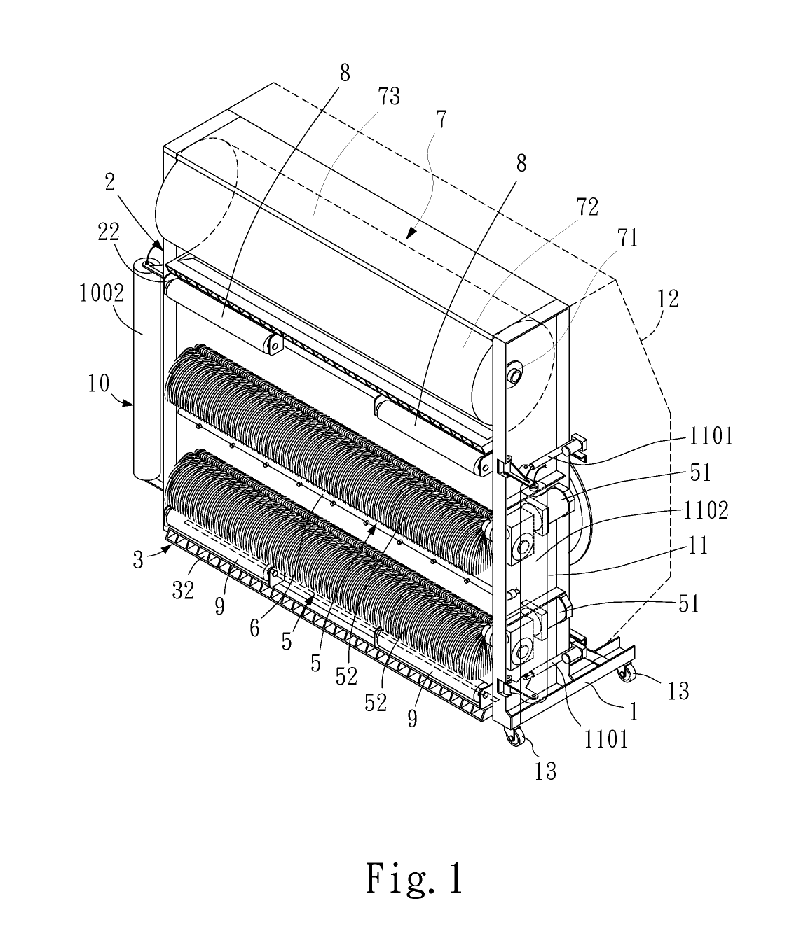

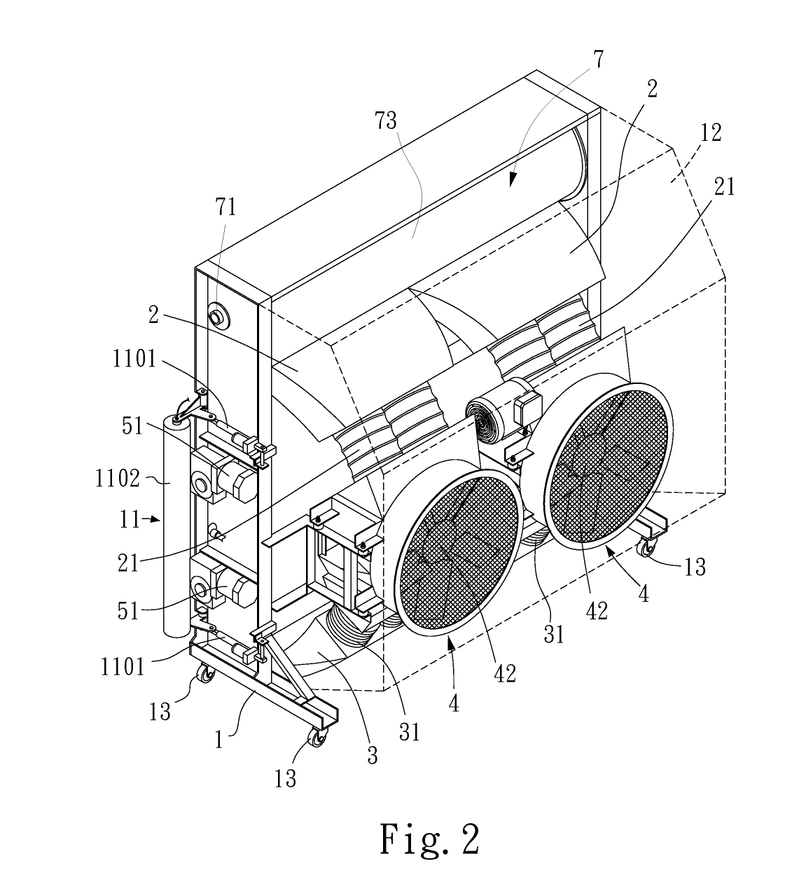

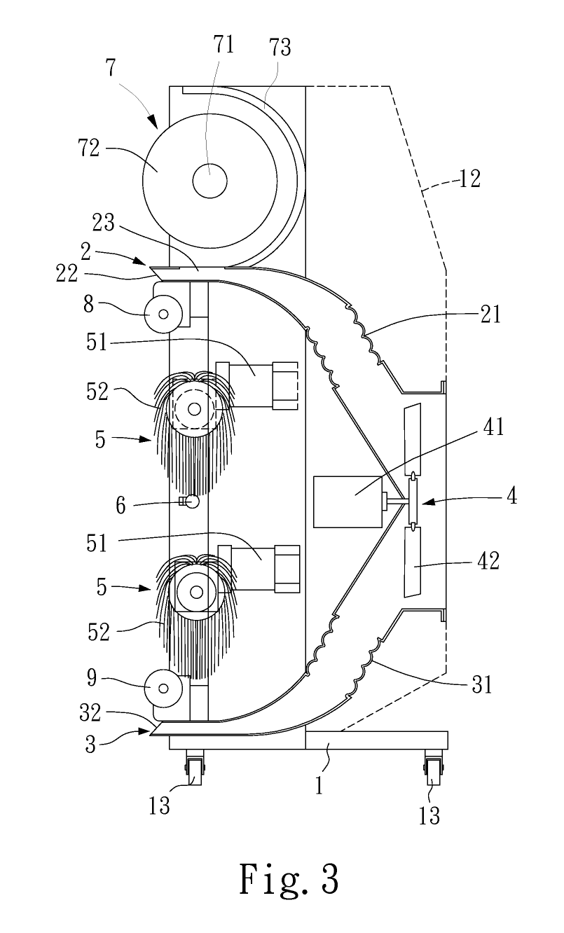

Referring to FIG. 1 through FIG. 3, there are shown a schematic front view, a schematic rear view and a cross-sectional view according to a specific embodiment of the present invention, respectively. As shown in the drawings, an outer wall cleaner of the present invention comprises a frame 1, an upper water inlet 2, a lower water inlet 3, at least a water-driving member 4, at least a scrubbing member 5, at least a water-spraying member 6 and a water-taking member 7. The upper water inlet 2 is disposed on a front side of the frame 1 and adapted to face an outer wall (not shown) of a building (not shown) so as to take water. The lower water inlet 3 is disposed on the front side of the frame 1 and adapted to face the outer wall of the building so as to take water. The at least a water-driving member 4 is disposed within the frame 1 and adapted to communicate with the upper water inlet 2 and the lower water inlet 3 by means of tubes 21, 31 so as to discharge water from another side of the frame 1. The water discharged by the water-driving member 4 undergoes nebulization. The nebulized water seldom ends up on a sidewalk below and thus is unlikely to contaminate the sidewalk or bring inconvenience to pedestrians. The at least a scrubbing member 5 is disposed on the front side of the frame 1, positioned between the upper water inlet 2 and the lower water inlet 3, and adapted to scrub the outer wall of the building. The water-spraying member 6 is disposed on the front side of the frame 1, positioned between the upper water inlet 2 and the lower water inlet 3, and adapted to spray water onto the outer wall of the building. The water-taking member 7 is disposed on the front side of the frame 1 and adapted to come into contact with the outer wall of the building and take water. The water-taking member 7 is positioned above the upper water inlet 2. An opening 23 is disposed on a water-taking-member-facing side of the upper water inlet 2. The scrubbing member 5 and the water-spraying member 6 are disposed between the upper water inlet 2 and the lower water inlet 3, such that the cleansing water is completely taken by the upper water inlet 2 and the lower water inlet 3 rather than ends up on a sidewalk below to contaminate the sidewalk or bring inconvenience to pedestrians.

The another side of the frame 1 is a rear side of the frame 1. The nebulized water is discharged from the rear side of the frame 1 and thus prevented from gaining access to the outer wall of the building.

In an embodiment, there is one said water-spraying member 6 and two said scrubbing members 5. The water-spraying member 6 is positioned between the scrubbing members 5, such that the outer wall cleaner equipped with the scrubbing members 5 and the water-spraying member 6 is effective in washing the outer wall of the building evenly.

The outer wall cleaner of the present invention further comprises at least an upper roller 8 and at least a lower roller 9 which are disposed on the front side of the frame 1. The upper roller 8 and the lower roller 9 roll across the outer wall of the building and thus enable the outer wall cleaner to move vertically on the outer wall of the building without coming into contact with the outer wall of the building, thereby protecting the outer wall cleaner against contact-induced damage. Also, the upper roller 8 and the lower roller 9 minimize the allowable distance between the front side of the outer wall cleaner and the outer wall of the building to thereby enhance the cleansing efficiency of the scrubbing member 5 and the performance of the upper water inlet 2 and the lower water inlet 3 in water intake.

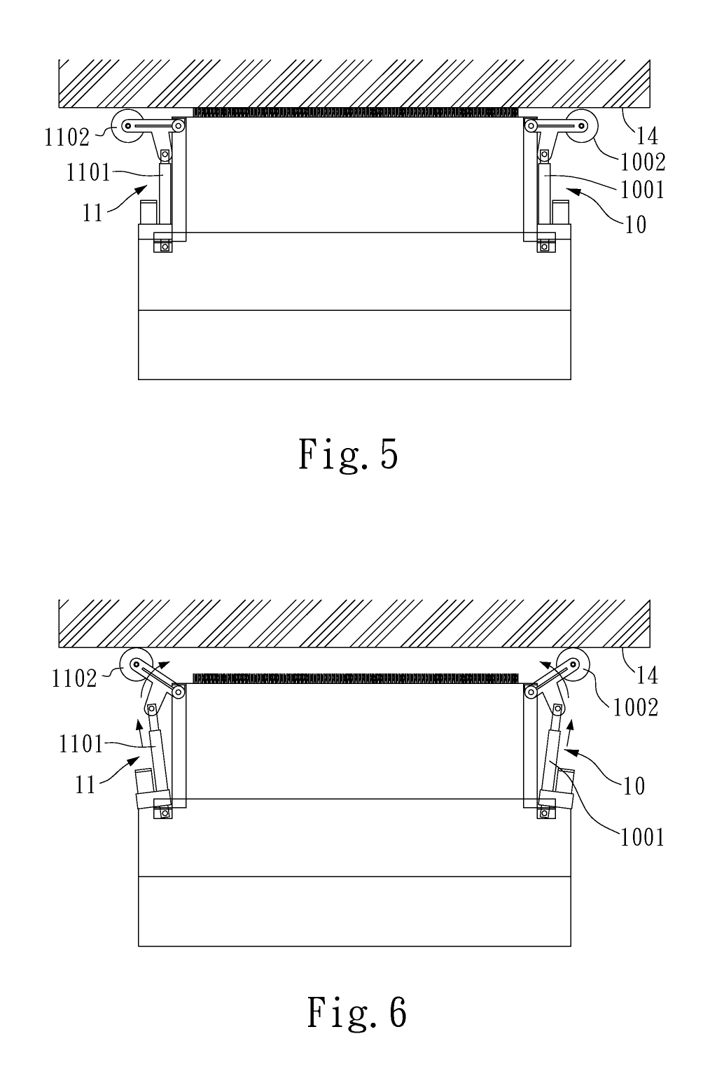

Referring to FIG. 5 and FIG. 6, there are shown schematic top views of application according to a specific embodiment of the present invention. As shown in the drawings, the outer wall cleaner of the present invention further comprises a left rolling member 11 and a right rolling member 10. The left rolling member 11 and the right rolling member 10 are disposed on the left side and the right side of the frame 1, respectively. The left rolling member 11 comprises a left retracting mechanism 1101 and a left roller 1102. The left roller 1102 is pivotally coupled to the left retracting mechanism 1101. The right rolling member 10 comprises a right retracting mechanism 1001 and a right roller 1002. The right roller 1002 is pivotally coupled to the right retracting mechanism 1001. The left roller 1102 and the right roller 1002 are movable forward by the left retracting mechanism 1101 and the right retracting mechanism 1001, respectively, to come into contact an outer wall 14 of the building but prevent the outer wall cleaner from coming into contact with the outer wall 14 of the building. Afterward, the left roller 1102 and the right roller 1002 can roll across the outer wall 14 of the building so as for the outer wall cleaner to move horizontally to an intended position before the retraction of the left roller 1102 and the right roller 1002. Operating in the aforesaid manner, the outer wall cleaner washes the outer wall 14 of the building in a top-to-bottom manner. The left retracting mechanism 1101 and the right retracting mechanism 1001 are pneumatic cylinders or hydraulic cylinders.

The upper water inlet 2 and the lower water inlet 3 have an upper slot 22 and a lower slot 32, respectively, which lie transversely. The water-driving member 4 comprises a first motor 41 and a fan 42. The first motor 41 is coupled to the frame 1 and adapted to drive the fan 42 to rotate. The scrubbing member 5 comprises a second motor 51 and a brush roller 52 which is transverse. The brush roller 52 has two ends pivotally coupled to two sides of the frame 1, respectively. The second motor 51 is coupled to the frame 1 and adapted to drive the brush roller 52 to rotate. The water-spraying member 6 lies transversely and sprays water. The water-taking member 7 comprises a water-taking roller 72 lying transversely, a curved baffle 73, and a third motor 71. The curved baffle 73, which is coupled to the frame 1, is disposed behind the water-taking roller 72 and spaced apart therefrom by a uniform distance. The third motor 71 drives the water-taking roller 72 to rotate. The water-taking roller 72 is peripherally made of a water-absorbing material, such as a fabric or foam, equipped with a transverse element, and adapted to enable the outer wall cleaner to wash the outer wall of the building extensively.

The outer wall cleaner of the present invention further comprises a shield 12 (indicated by a dashed line in FIG. 1 through FIG. 4) disposed on the rear side of the frame 1. As shown in the drawings, all of the constituent elements of the outer wall cleaner of the present invention are hidden by the shield 12, except the water-driving member 4. The shield 12 not only gives protection to the constituent elements but also provides an aesthetic appearance of the outer wall cleaner.

The outer wall cleaner of the present invention further comprises a plurality of bottom rollers 13 pivotally coupled to the bottom of the frame 1 and adapted to enable the outer wall cleaner to be pushed or pulled by a building cleaning worker while the outer wall cleaner is idle and being moved on the ground.

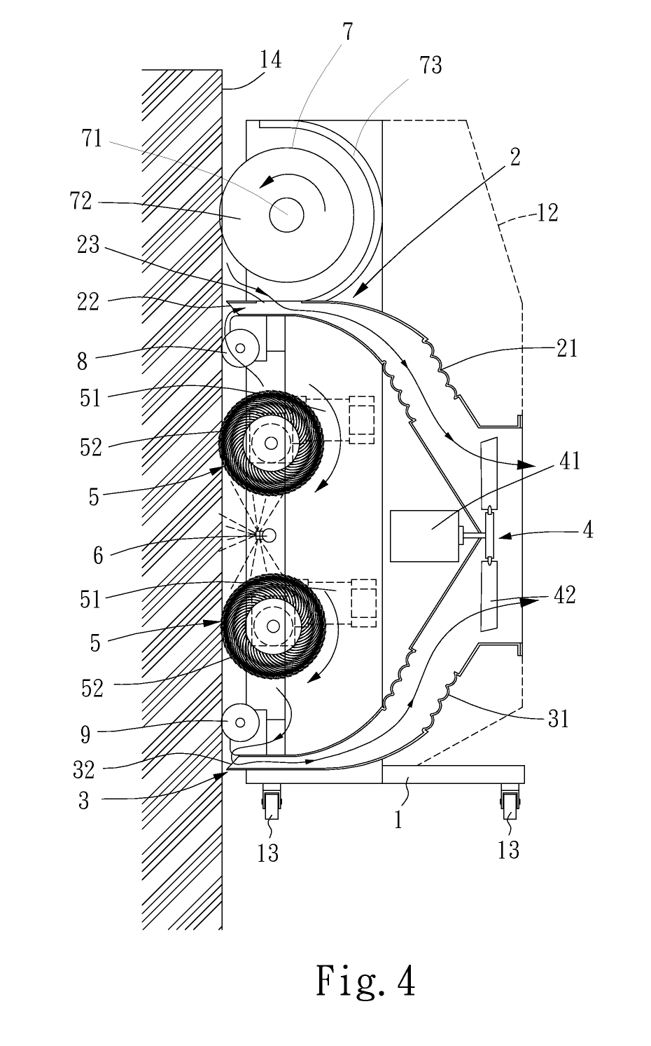

Referring to FIG. 4, there is shown a cross-sectional view of application according to a specific embodiment of the present invention. As shown in the drawing, the outer wall cleaner of the present invention operates in a manner described hereunder. Two ropes (not shown) are fastened to two sides of the outer wall cleaner, respectively. Then, the outer wall cleaner is hung on the outer wall 14 of the building. The outer wall cleaner moves across the outer wall 14 of the building while being pulled or lowered by means of the two ropes. The movement of the outer wall cleaner across the outer wall 14 of the building is smooth due to the upper roller 8 and the lower roller 9 of the outer wall cleaner. To give a thorough wash to the outer wall 14 of the building in the course of the movement of the outer wall cleaner across the outer wall 14 of the building, not only does the water-spraying member 6 spray cleansing water onto the outer wall 14 of the building and the brush roller 52, but the brush roller 52 is driven by the second motor 51 to scrub the outer wall 14 of the building. To prevent the cleansing water from falling under gravity to thereby contaminate a sidewalk below or bring inconvenience to pedestrians, the outer wall cleaner of the present invention provides two solutions which can work concurrently. First, the fan 42 of the water-driving member 4 is driven by the first motor 41 to rotate, such that the fan 42 in operation provides a force of suction whereby the cleansing water inevitably scattered about by the brush roller 52 is sucked into the upper water inlet 2 and the lower water inlet 3 through the upper slot 22 and the lower slot 32, respectively, thereby allowing the captured cleansing water to be mixed with air and nebulized by means of fan 42; in doing so, the nebulized water is eventually discharged from the rear side of the frame 1. Second, the water-taking roller 72 of the water-taking member 7, which is driven by the third motor 71, rolls across the outer wall 14 of the building to collect residual water therefrom and wipe the outer wall 14 of the building, and then the residual water collected by the water-taking roller 72 is forcibly removed therefrom under a centrifugal force generated by the rotation of the water-taking roller 72; as a result, the forcibly removed residual water hits the curved baffle 73 before being admitted to the opening 23 of the upper water inlet 2 and discharged from the rear side of the frame 1 by means of the water-driving member 4. As shown in FIG. 5 and FIG. 6, after the outer wall cleaner has finished washing the outer wall 14 of the building in the course of the vertical movement of the outer wall cleaner across the outer wall 14 of the building, the outer wall cleaner moves leftward or rightward to reach an appropriate position by means of the left rolling member 11 or the right rolling member 10 and starts, from the appropriate position, to wash the outer wall 14 of the building in the aforesaid manner.

Hence, the present invention meets the three requirements of patentability, namely novelty, non-obviousness, and industrial applicability. Regarding novelty and non-obviousness, the present invention discloses an upper water inlet, a lower water inlet, and a water-taking member whereby the cleansing water does not fall or splash, and thus it is feasible to clean an outer wall of a building safely without contaminating an area below the outer wall. Regarding industrial applicability, products derived from the present invention meet existing market demands fully.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. An outer wall cleaner, comprising:
a frame;
an upper water inlet disposed on a front side of the frame and adapted to face an outer wall of a building so as to take water;
a lower water inlet disposed on the front side of the frame and adapted to face the outer wall of the building so as to take water;
at least a water-driving member disposed within the frame and adapted to communicate with the upper water inlet and the lower water inlet so as to discharge water from another side of the frame;
at least a scrubbing member disposed on the front side of the frame, positioned between the upper water inlet and the lower water inlet, and adapted to scrub the outer wall of the building;
at least a water-spraying member disposed on the front side of the frame, positioned between the upper water inlet and the lower water inlet, and adapted to spray water onto the outer wall of the building; and
a water-taking member disposed on the front side of the frame, adapted to come into contact with the outer wall of the building and take water, and positioned above the upper water inlet, wherein an opening is disposed on a water-taking-member-facing side of the upper water inlet.

2. The outer wall cleaner of claim 1, wherein the another side of the frame is a rear side of the frame.

3. The outer wall cleaner of claim 1, further comprising two said scrubbing members and one said water-spraying member positioned therebetween.

4. The outer wall cleaner of claim 1, further comprising at least an upper roller and at least a lower roller which are disposed on the front side of the frame and adapted to roll across the outer wall of the building so as for the outer wall cleaner to move thereon vertically.

5. The outer wall cleaner of claim 1, further comprising a left rolling member and a right rolling member which are disposed on a left side and a right side of the frame, respectively, the left rolling member comprising a left retracting mechanism and a left roller pivotally coupled thereto, the right rolling member comprising a right retracting mechanism and a right roller pivotally coupled thereto, wherein the left roller and the right roller are movable forward by the left retracting mechanism and the right retracting mechanism, respectively, to come into contact with the outer wall of the building and roll across the outer wall of the building so as to enable the outer wall cleaner to move horizontally.

6. The outer wall cleaner of claim 1, wherein the upper water inlet and the lower water inlet have an upper slot lying transversely and a lower slot lying transversely, respectively, wherein the water-driving member comprises a fan and a first motor for driving the fan to rotate, wherein the scrubbing member comprises a brush roller lying transversely and a second motor for driving the brush roller to rotate, wherein the water-spraying member lies transversely and sprays water, wherein the water-taking member comprises a water-taking roller lying transversely, a curved baffle disposed behind the water-taking roller and spaced apart therefrom by a uniform distance, and a third motor for driving the water-taking roller to rotate.

7. The outer wall cleaner of claim 1, further comprising a shield disposed on the rear side of the frame.

8. The outer wall cleaner of claim 1, further comprising a plurality of bottom rollers pivotally coupled to the bottom of the frame.
